(19) United States
(12) Patent Application Publication
(10) Pub. No.: US 2009/0239641 A1
(43) Pub. Date: Sep. 24, 2009

(54) Gaming Machine Capable of Selecting a Feature Game to be Executed When Accepting an Additional Bet, and Control Method Thereof

(75) Inventor: Fumiya Abe, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Gaming America, Inc., Las Vegas, NV (US)

(21) Appl. No.: 12/404,708

(22) Filed: Mar. 16, 2009

Related U.S. Application Data
(60) Provisional application No. 61/038,488, filed on Mar. 21, 2008.

(51) Int. Cl. A63F 9/24; A63F 13/00

(52) U.S. Cl. 463/20; 463/30

(57) ABSTRACT

A CPU of a gaming machine can accept a side bet, in addition to a bet for a basic game. In a case where the side bet is accepted, a selection screen is displayed on a liquid crystal display, which allows a selection of a feature game that is executed in a case where a predetermined condition is met in the basic game. After receiving the player's selection of a feature game from a plurality of feature games, the CPU executes the selected feature game. On the contrary, in a case where no side bet has been made, the CPU randomly selects and executes a feature game.

### CROSS REFERENCE TO RELATED APPLICATIONS

This application claims benefit of U.S. Provisional Application No. 61/038,488, filed Mar. 21, 2008, the entire contents of which are incorporated herein by reference.

### BACKGROUND OF THE INVENTION

1. Field of the Invention

The present invention relates to a gaming machine including a plurality of feature games, in which a player can select a feature game to be executed in a case where an additional bet is accepted, and a control method thereof.

2. Related Art

Conventionally, gaming machines executing feature games such as bonus games, that are different from basic games, in a case where predetermined symbols are statically displayed in a predetermined way, are known. In addition, as disclosed in U.S. Pat. No. 7,329,179, gaming machines including a plurality of kinds of feature games, in which a specific feature game is executed in accordance to the type, position, and number of stationary symbols, or a specific feature game is randomly executed from a plurality of feature games, are known. With such gaming machines, a feature game to be executed is automatically determined and players cannot select a desired feature game.

On the other hand, by making feature games always selectable by players, players do not have an opportunity to expect a feature game selected from a plurality of feature games, thus making the game less exciting.

Therefore, an objective of the present invention is to provide a gaming machine including a plurality of feature games, in which a player can select a feature game to be executed in a case where the player has made an additional bet, thus allowing the player to enjoy a desired feature game and motivating the player, and a control method thereof.

### SUMMARY OF THE INVENTION

In a first aspect of the present invention, a gaming machine includes: a display for displaying a predetermined symbol from each of a plurality of symbol groups; an input device for accepting a selection of a second game from a plurality of second games in a case in which an additional bet is accepted, where the additional bet is made together with a bet for a first game; memory for storing the additional bet; and a controller for executing steps of: (a) storing the additional bet in the memory; (b) generating random numbers and starting the first game; (c) dynamically displaying each of the plurality of symbol groups on the display; (d) determining the symbol to be statically displayed on the display, in accordance with the random numbers; (e) statically displaying each of the symbols determined in step (d); (f) determining whether a trigger symbol is displayed in a predetermined way among the plurality of symbols, in which the trigger symbol triggers a transition to the second game; (g) in response to the processing of step (f), displaying a selection image on the display for selecting the second game to be executed, in a case where a transition to the second game is taking place and where the additional bet is being accepted; (h) executing the second game in response to the selection thereof by the input device; and (i) clearing the additional bet stored in the memory.

According to a second aspect of the present invention, in the gaming machine according to the first aspect, in a case where the additional bet is not being accepted, the controller randomly selects the second game from the plurality of second games in steps (g) and (h).

In a third aspect of the present invention, a gaming machine includes: a display for displaying a predetermined symbol from each of a plurality of symbol groups; an input device for accepting a selection of a second game from a plurality of second games in a case in which an additional bet is accepted, where the additional bet is made together with a bet for a first game; memory for storing the additional bet; and a controller for executing steps of: (a) in a case where the additional bet is accepted, storing a value of the additional bet in the memory by adding to a value stored in the memory; (b) generating random numbers and starting the first game; (c) dynamically displaying each of the plurality of symbol groups on the display; (d) determining a symbol to be statically displayed on the display, in accordance with the random numbers; (e) statically displaying the symbol on the display, in response to the processing of step (d); (f) determining whether a trigger symbol is displayed in a predetermined way among the plurality of symbols, in which the trigger symbol triggers a transition to the second game; (g) in response to the processing of step (f), displaying a selection image on the display for selecting the second game to be executed, in a case where a transition to the second game is taking place and where the additional bet is being accepted; (h) executing the second game in response to the selection thereof by the input device; and (i) subtracting a value corresponding to the second game executed in step (h) from the value of the additional bet, and storing the result thereof in the memory.

According to a fourth aspect of the present invention, in the gaming machine according to the third aspect is provided, in a case where the additional bet is not being accepted, the controller randomly selects the second game from the plurality of second games in steps (g) and (h).

According to a fifth aspect of the present invention, in a control method for a gaming machine including: a display for displaying a predetermined symbol from each of a plurality of symbol groups; an input device for accepting a selection of a second game from a plurality of second games in a case in which an additional bet is accepted, where the additional bet is made together with a bet for a first game; memory for storing a value of the additional bet; and a controller for executing the method, the method includes steps of: (a) storing the additional bet in the memory; (b) generating random numbers and starting the first game; (c) dynamically displaying each of the plurality of symbol groups on the display; (d) determining the symbol to be statically displayed on the display, in accordance with the random numbers; (e) statically displaying each of the symbols determined in step (d); (f) determining whether a trigger symbol is displayed in a predetermined way among the plurality of symbols displayed, in which the trigger symbol triggers a transition to the second game; (g) in response to the processing of step (f), displaying a selection image on the display for selecting the second game to be executed, in a case where a transition to the second game is taking place and where the additional bet is being accepted; (h) executing the second game in response to the selection thereof by the input device; and (i) clearing the additional bet stored in the memory.

According to a sixth aspect of the present invention, in the control method for the gaming machine according to the fifth aspect is provided, in a case where the additional bet is not being accepted, the controller randomly selects the second game from the plurality of second games in steps (g) and (h).

According to a seventh aspect of the present invention, in a control method for a gaming machine including: a display for displaying a predetermined symbol from each of a plurality of symbol groups; an input device for accepting a selection of a second game from a plurality of second games in a case in which an additional bet is accepted, where the additional bet is made together with a bet for a first game; memory for storing the additional bet; and a controller for executing the method, the method includes: (a) in a case where the additional bet is accepted, storing a value of the additional bet in the memory by adding to a value stored in the memory; (b) generating random numbers and starting the first game; (c) dynamically displaying each of the plurality of symbol groups on the display; (d) determining a symbol to be statically displayed on the display, in accordance with the random numbers; (e) statically displaying the symbol on the display, in response to the processing of step (d); (f) determining whether a trigger symbol is displayed in a predetermined way in the plurality of symbols, in which the trigger symbol triggers a transition to the second game; (g) in response to the processing of step (f), displaying a selection image on the display for selecting the second game to be executed, in a case where a transition to the second game is taking place and where the additional bet is being accepted; (h) executing the second game in response to the selection thereof by the input device; and (i) subtracting a value corresponding to the second game executed in step (h) from the value of the additional bet, and storing the result thereof in the memory.

According to an eighth aspect of the present invention, in the control method according to the seventh aspect is provided, in a case where the additional bet is not being accepted, the controller randomly selects the second game from the plurality of second games in steps (g) and (h).

### BRIEF DESCRIPTION OF THE DRAWINGS

FIG. 1 is a flow chart showing the flow of a game executed in a gaming machine according to an embodiment of the present invention;

FIG. 2 is a perspective view showing the appearance of the gaming machine according to the embodiment;

FIG. 3 is an enlarged front view showing a display area of the gaming machine according to the embodiment;

FIG. 4 is a block diagram of a controller of the gaming machine according to the embodiment;

FIG. 5 is a block diagram of a display/input controller of the gaming machine according to the embodiment;

FIG. 6 is a diagram showing columns of symbols displayed on the respective video reels of the gaming machine according to the embodiment;

FIG. 7 is a diagram showing a symbol layout table according to the embodiment;

FIGS. 8 and 9 show a flow chart of basic game processing executed in the gaming machine according to the embodiment;

FIG. 10 shows a flow chart of feature game selection processing executed in the gaming machine according to the embodiment;

FIG. 11 is a diagram showing a feature game selection table according to the embodiment;

FIG. 12 is a diagram showing a display example of selecting a feature game according to the embodiment;

FIG. 13 is a flowchart for basic game processing executed by the gaming machine according to a second embodiment of the present invention; and

FIG. 14 shows a flow chart of feature game selection processing executed in the gaming machine according to the second embodiment.

### DETAILED DESCRIPTION OF THE INVENTION

An embodiment of the present invention is described below with reference to the accompanying drawings.

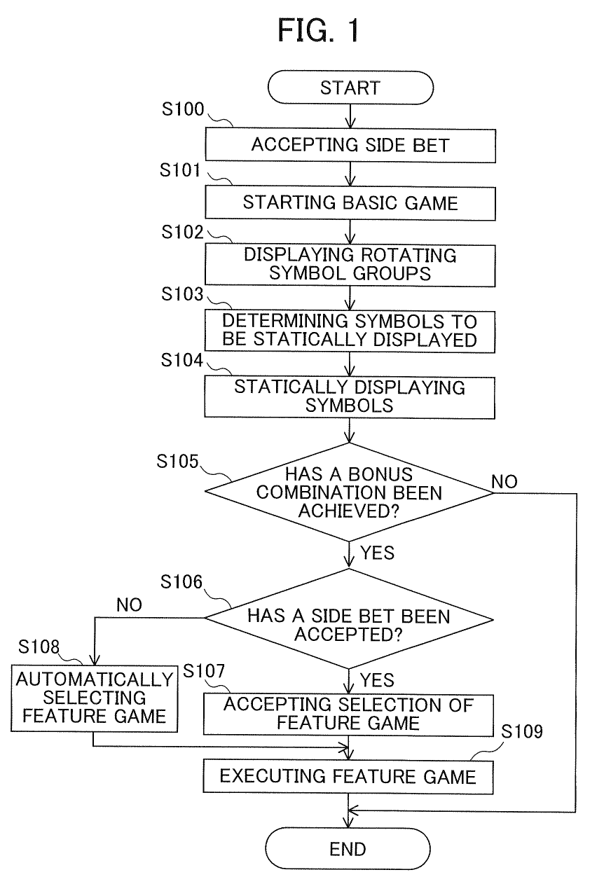

More specifically, in a gaming machine 13 according to the present invention, as shown in FIG. 1, CPU 106 first stores a side bet in RAM 110 in response to a signal received from a side bet switch 4 (Step S100). Details thereof are described later. Consequently, the CPU 106 starts a basic game in response to a signal received from a start switch 25 (Step S101), rotatably displays symbol groups on video reels 3A to 3E in response to the start of the basic game (Step S102), and determines a symbol to be statically displayed on each of the video reels 3A to 3E (Step S103). Then, the CPU 106 statically displays the symbols on the video reels 3A to 3E (Step S104), determines whether the symbols form a combination qualified for a bonus or not (Step S105), and, in the case of a YES determination, advances to Step S106, and in the case of a NO determination, terminates the routine. In Step S106, the CPU 106 determines whether a side bet is accepted or not. In the case of a YES determination, the CPU 106 accepts a selection of a feature game to be executed from a plurality of feature games by the player (Step S107), and in the case of a NO determination, the CPU 106 selects a feature game (Step S108). Furthermore, the CPU 106 executes the selected feature game (Step S109), and terminates the routine.

In other words, the gaming machine 13 of the present invention allows players to select a feature game to be executed from a plurality of feature games, by accepting a side bet in addition to a bet in a basic game.

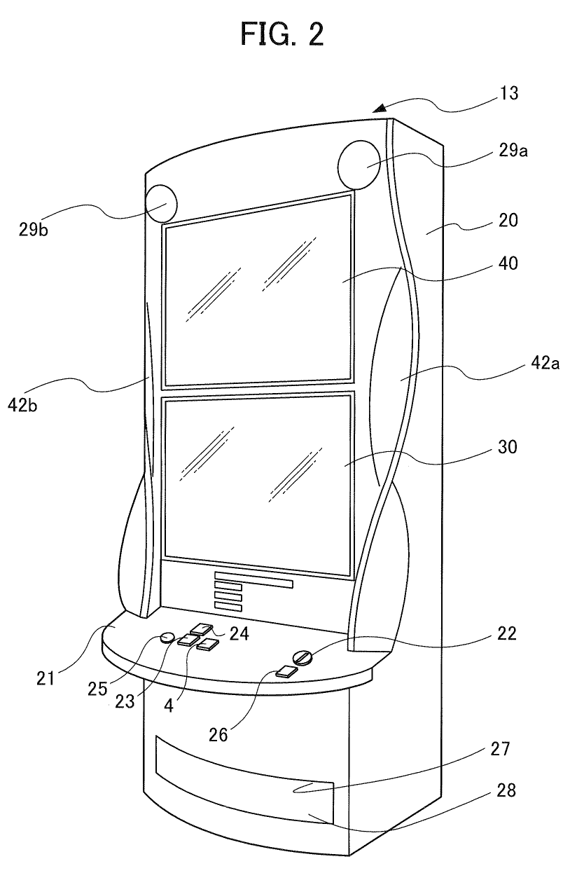

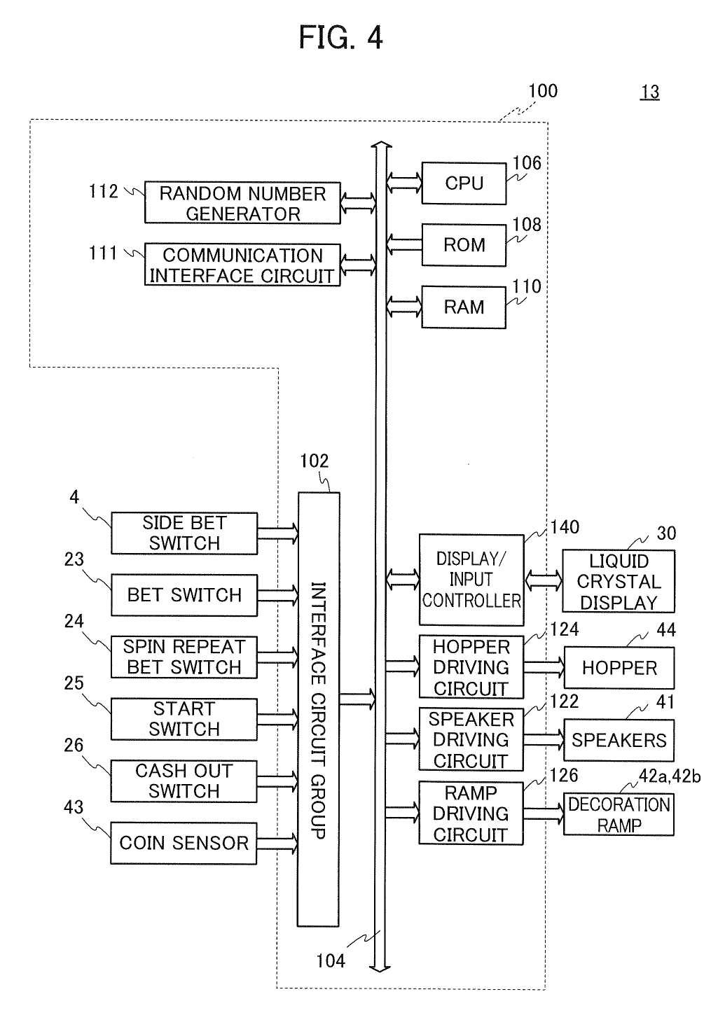

FIG. 2 is a perspective view showing the gaming machine 13 according to an embodiment of the present invention. The gaming machine 13 includes a cabinet 20. The cabinet 20 has a surface opening toward a player. The cabinet 20 contains various components including a game controller 100 (refer to FIG. 4) for electrically controlling the gaming machine 13, and a hopper 44 (refer to FIG. 4) for controlling the insertion, storage, and payout of coins (as game media), and the like. The game media is not limited to coins, and it can be, for example, medals, tokens, electronic money, or electronic valuable information (credits) equivalent thereto.

A liquid crystal display 30 is disposed at substantially the center of the front face of the cabinet 20, and a liquid crystal display 40 is disposed above the display 30.

The liquid crystal display 30 is provided as a display device for displaying various kinds of images relating to the game such as rendered images. The player advances the game while observing the variety of images displayed on the liquid crystal display 30. In such a game, the liquid crystal display 30 displays a slot game and the mini game as described later.

The gaming machine 13 includes a video reel, which displays five virtual reels on the liquid crystal display 30. In addition, it should be noted that the term “video reel” as used here represents a mechanism for displaying a reel on the liquid crystal display 30 in the form of an image, instead of a mechanical reel. A plurality of symbols necessary for the game such as “BONUS,” “WILD,” “TREASURE BOX,” “GOLDEN MASK,” “HOLY GRAIL,” “COMPASS & MAP,” “SNAKE,” “A,” “K,” “Q”, “J,” and “10” are displayed in the image of rotating reels.

Another liquid crystal display 40 disposed above the liquid crystal display 30 is a sub display for displaying the rules of the game, demonstration movies, and the like.

In addition, sound transmission openings 29a and 29b are provided on both the left and right sides above the liquid crystal display 40, which allow the sound effects generated by a speaker 41 (see FIG. 4) stored within the cabinet 20 to propagate outside the cabinet 20. The sound effects are generated from the sound transmission openings 29a and 29b according to the advancement of the game. In addition, decorative lamps 42a and 42b are provided on both left and right sides, substantially in the middle of the gaming machine 13. The decorative lamps 42a and 42b emit light in accordance with the progress of the game.

A substantially horizontal operation unit 21 is disposed below the liquid crystal display 30. Furthermore, a coin slot 22, which allows the player to insert coins, is provided on the right side of the operation unit 21. On the other hand, the components provided to the left side of the operation unit 21 include: a BET switch 23 which allows the player to determine which lines are to be set to active pay lines among nine lines L1, L2, L3, L4, L5, L6, L7, L8, and L9, for providing an award described later (which will simply be referred to as “active pay lines” hereafter), and which allows the player to select the number of coins as gaming media to be bet on the aforementioned active pay lines; and a spin repeat bet switch 24 which allows the player to play the game again without changing the number of coins bet on the aforementioned active pay lines from that in the immediately previous game. Such an arrangement allows the player to set the number of coins bet on the aforementioned active pay lines by pushing either the BET switch 23 or the spin repeat bet switch 24.

In the operation unit 21, a start switch 25 for accepting a starting operation of each game by a player is disposed on the left side of the bet switch 23. A pushing operation on either the start switch 25 or the spin repeat bet switch 24 triggers the start of the game, and the liquid crystal display 30 displays an image of the aforementioned five video reels 3A through 3E, which then start to rotate.

In addition, a side bet switch 4 is provided on the right side of the bet switch 23 in the operation unit 21. The side bet switch 4 is a switch for making a side bet. The side bet is made by a player to make a feature game selectable, where the feature game is executed in a case where a trigger symbol is displayed in a predetermined way in the basic game. By making the side bet, players can select a desired feature game from a plurality of feature games, in a case where the feature game is being executed. Details are described later.

On the other hand, a cash out switch 26 is provided near the coin slot 22 on the aforementioned operation unit 21. When the player pushes the cash out switch 26, the inserted coins are discharged from a coin payout opening 27 in a lower portion of the front face of the cabinet 20. The discharged coins can be collected on a coin tray 28.

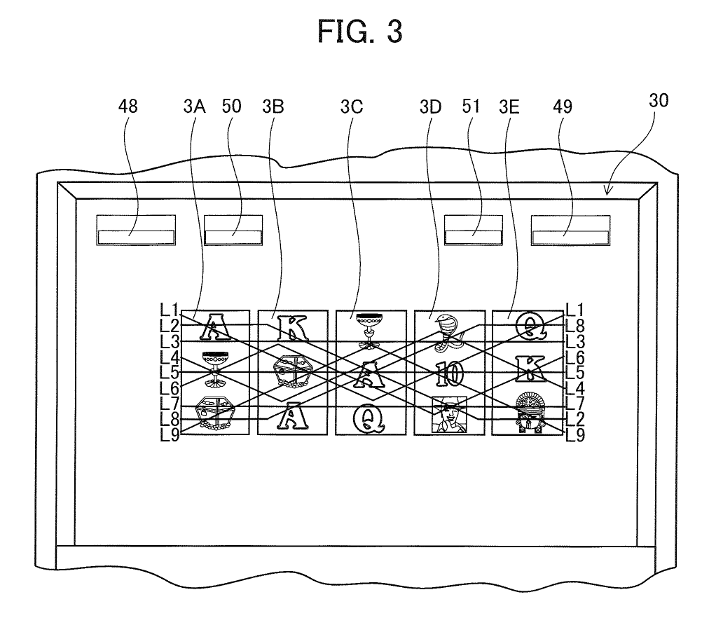

FIG. 3 is an enlarged view showing the display region of the gaming machine 13. As shown in FIG. 3, the gaming machine 13 has nine lines L1 to L9 for providing awards. The lines L1 to L9 extend so as to pass through a symbol on each of the video reels 3A to 3E, when all of the spinning five video reels 3A to 3E come to a stop.

Pressing the bet switch 23 once will activate, for example, the line L3 for providing a third award, the line L5 for providing a fifth award, and the line L7 for providing a seventh award, and also will consume a coin as a credit medal.

Pressing the bet switch 23 twice will activate, for example, the line L1 for providing a first award, the line L4 for providing a fourth award, and the line L8 for providing an eighth award, in addition to the abovementioned three lines, and also will consume two coins as credit medals.

Pressing the bet switch 23 three times will activate, for example, the line L2 for providing a second award, the line L6 for providing a sixth award, and the line L9 for providing a ninth award, in addition to the abovementioned six lines, and also will consume three coins as credit medals.

The game available in the present embodiment is a game in which a predetermined set of symbols are formed along the active pay lines.

Furthermore, the liquid crystal display 30 displays, on the upper portion of the reels 3A to 3E, starting from the left, a payout display portion 48, a BET amount display portion 50, a side bet display portion 51, and a credit amount display portion 49. The payout display portion 48 displays the number of coins to be discharged in a case where a combination for providing an award is achieved along the active pay lines. The credit amount display portion 49 displays the credit amount of coins stored in the gaming machine 13. The BET amount display portion 50 displays the BET amount which is the number of coins bet on the aforementioned active pay lines. The side bet display portion 51 indicates the receipt of a side bet, or displays the side bet amount.

FIG. 4 is a block diagram showing the electrical configuration of the game controller 100 of the gaming machine 13. As shown in FIG. 4, the game controller 100 of the gaming machine 13 is a micro computer, and includes an interface circuit group 102, an input/output bus 104, a CPU 106, ROM 108, RAM 110, a communication interface circuit 111, a random number generator 112, a speaker driving circuit 122, a hopper driving circuit 124, a lamp driving circuit 126, and a display/input controller 140.

The interface circuit group 102 is connected to the input/output bus 104. The input/output bus 104 performs input/output of data signals or address signals to and from the CPU 106.

The start switch 25 is connected to the interface circuit group 102. A start signal output from the start switch 25 is converted to a predetermined signal by the interface circuit group 102, and is then supplied to the input-output bus 104.

The BET switch 23, the spin repeat bet switch 24, and the cash out switch 26 are also connected to the interface circuit group 102. Switching signals output from the switches are also supplied to the interface circuit group 102 and converted to predetermined signals, and then supplied to the input-output bus 104 by the interface circuit group 102.

A coin sensor 43 is also connected to the interface circuit group 102. The coin sensor 43 is a sensor for detecting the coins inserted into the coin slot 22. The coin sensor 43 is provided in combination with the coin slot 22. A sensing signal outputted from the coin sensor 43 is also supplied to the interface circuit group 102 and converted into a predetermined signal by the interface circuit group 102, and then supplied to the input/output bus 104.

The ROM 108 and the RAM 110 are connected to the input/output bus 104.

Upon acceptance of the start operation of a game from the start switch 25, the CPU 106 reads and executes a game program. The game program starts displaying the scrolling of the symbols on the five video reels 3A to 3E on the liquid crystal display 30 via the display/input controller 140, and then statically displays the five video reels 3A to 3E, to rearrange the five video reels. In a case where a combination of the stationary symbols is displayed along the active pay lines and the combination corresponds to a specific combination for providing an award, the game program pays out an amount of coins corresponding to the specific combination.

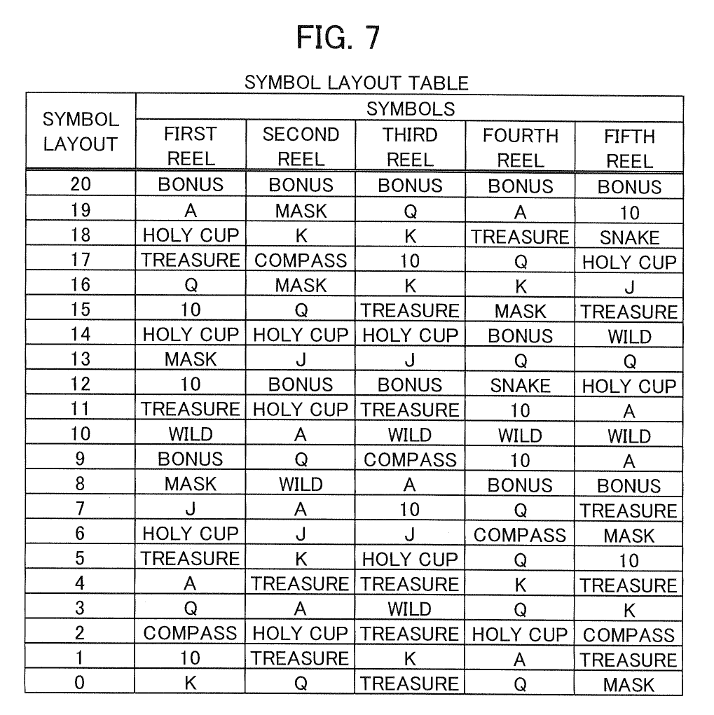

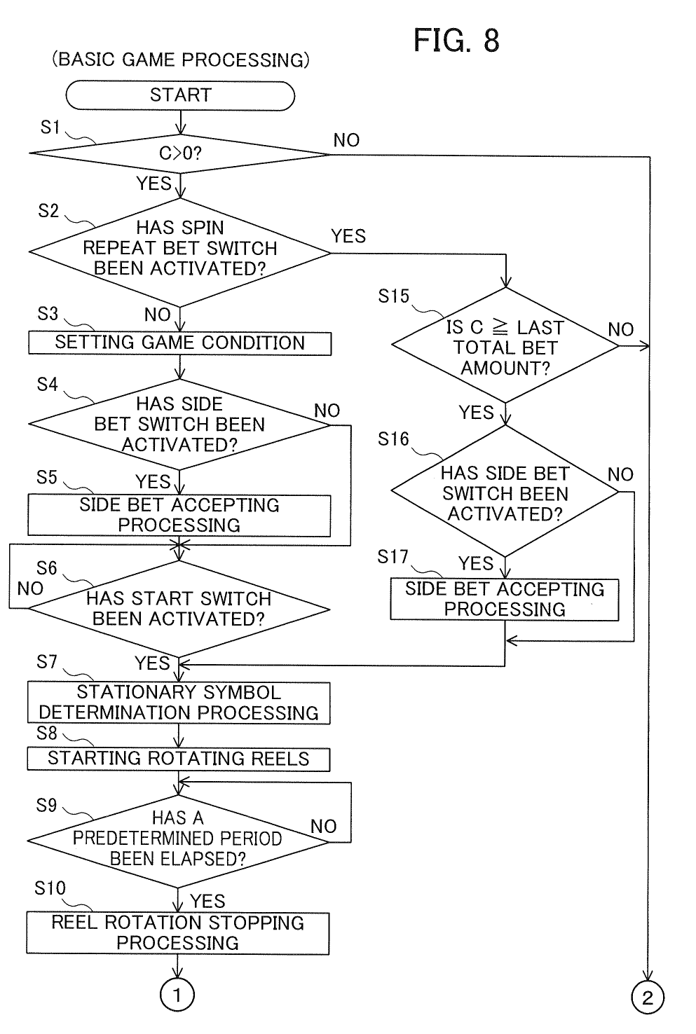

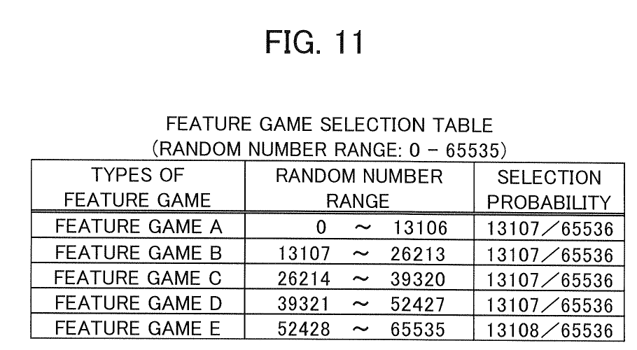

The ROM 108 stores a control program for governing and controlling the gaming machine 13, a program for executing routines as shown in FIGS. 8, 9 and 10 (hereinafter referred to as a “routine execution program”), and initial data for executing the control program, and various data tables used in decision processes. The routine execution program includes the abovementioned game program. Examples of the data tables include tables such as those shown in FIGS. 7 and 11. The RAM 110 temporarily stores flags, variables, the side bet amount and the like used for the abovementioned control program.

A communication interface circuit 111 is also connected to the input/output bus 104. The communication interface circuit 111 is a circuit for communicating with, for example, external communication devices such as a server, via the network 12 including various kinds of networks such as a LAN.

A random number generator 112 for generating random numbers is also connected to the input-output bus 104. The random number generator 112 generates random numbers included in a certain range of numerical values, for example, 0 to 65535 (2¹⁶-1). Alternatively, the random numbers may be generated by the arithmetic processing of the CPU 106.

A speaker driving circuit 122 for driving the speaker 41 is also connected to the input/output bus 104. The CPU 106 reads sound data stored in the ROM 108, and transmits the sound data to the speaker driving circuit 122 via the input/output bus 104. Thus, predetermined sound effects are output from the speaker 41.

A hopper driving circuit 124 for driving the hopper 44 is also connected to the input/output bus 104. Upon receipt of a cash out signal input from the cash out switch 26, the CPU 106 transmits a driving signal to the hopper driving circuit 124 via the input/output bus 104. This enables the hopper 44 to pay out a number of coins corresponding to the remainder of credits at that point, which is stored in a predetermined memory area of the RAM 110.

Alternatively, the payout of the coins may be performed in a mode of storing credit data in a data card or the like, instead of using physical coins. That is to say, with such an arrangement, the player may have his/her own card, which serves as a storage medium. Upon the player inserting this card into the gaming machine 13, the data relating to the credits is stored in the card.

A lamp driving circuit 126 is also connected to the input/output bus 104 for driving the decorative lamps 42a and 42b. The CPU 106 sends signals for driving the lamps under a predetermined condition based on the program stored in the ROM 108, to the lamp driving circuit 126. This causes the decorative lamps 42a and 42b blink.

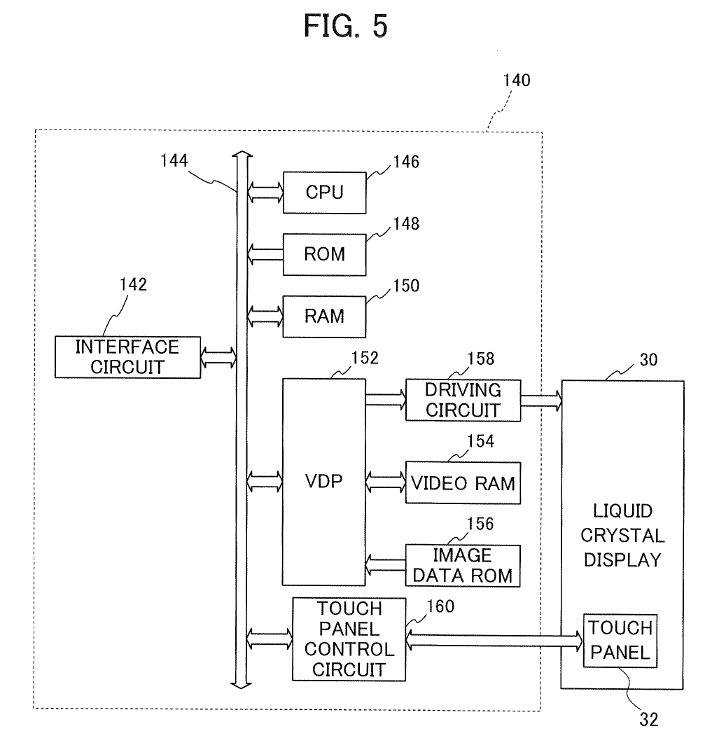

The display/input controller 140 is also connected to the input/output bus 104. The CPU 106 generates an image display instruction according to the state of the game and the result of the game, and outputs the generated image display instruction to the display/input controller 140 via the input/output bus 104. Upon receipt of the image display instruction input from the CPU 106, the display/input controller 140 generates a driving signal for driving the liquid crystal display 30 according to the image display instruction, and outputs the driving signal thus generated to the liquid crystal display 30. As a result, a predetermined image is displayed on the liquid crystal display 30. The display/input controller 140 also includes a touch panel 32 on the liquid crystal display 30 (see FIG. 5). The display/input controller 140 transmits the signal input through the touch panel 32 to the CPU 106 via the input/output bus 104, in the form of an input signal. It should be noted that the image display instructions include instructions relating to the payout amount display portion 48, the credit amount display portion 49, the side bet display portion 51 and the bet amount display portion 50.

FIG. 5 is a block diagram showing the electrical configuration of the display/input controller 140 of the gaming machine 13. The display/input controller 140 of the gaming machine 13 is a sub-microcomputer for performing image display processing and input control for the touch panel 32. The display/input controller 140 includes an interface circuit 142, an input/output bus 144, a CPU 146, ROM 148, RAM 150, a VDP 152, video RAM 154, image data ROM 156, a driving circuit 158, and a touch panel control circuit 160.

The interface circuit 142 is connected to the input/output bus 144. An image display command output from the CPU 106 of the aforementioned game controller 100 is supplied to the input/output bus 144 via the interface circuit 142. The input/output bus 144 performs input/output of data signals or address signals to and from the CPU 146.

ROM 148 and RAM 150 are connected to the input/output bus 144. The ROM 148 stores a display control program for generating a driving signal, which is to be supplied to the liquid crystal display 30, according to an image display command received from the CPU 106 of the aforementioned game controller 100. On the other hand, the RAM 150 stores flags and values of variables used in the display control program.

The VDP 152 is also connected to the input/output bus 144. The VDP 152 is a processing device including a so-called sprite circuit, a screen circuit, a palette circuit and the like, and is capable of performing various processing for displaying an image on the liquid crystal display 30. The video RAM 154 and the image data ROM 156 are connected to the VDP 152. The video RAM 154 stores image data based on the image display instructions from the CPU 106 on the game controller 100. The image data ROM 156 stores various kinds of image data containing the abovementioned rendered image data. Furthermore, the driving circuit 158 for outputting a driving signal for driving the liquid crystal display 30 is connected to the VDP 152.

By reading and executing the display control program stored in the ROM 148, the CPU 146 instructs the video RAM 154 to store image data to be displayed on the liquid crystal display 30 in response to the image display instructions from the CPU 106 on the game controller 100. The image display instructions include various types of image display instructions, such as the abovementioned display instruction of a rendered image.

The image data ROM 156 stores various kinds of image data including the rendered image data.

The touch panel control circuit 160 transmits to the CPU 106 the signals input via the touch panel 32, provided on the liquid crystal display 30, via the input/output bus 144, in the form of an input signal.

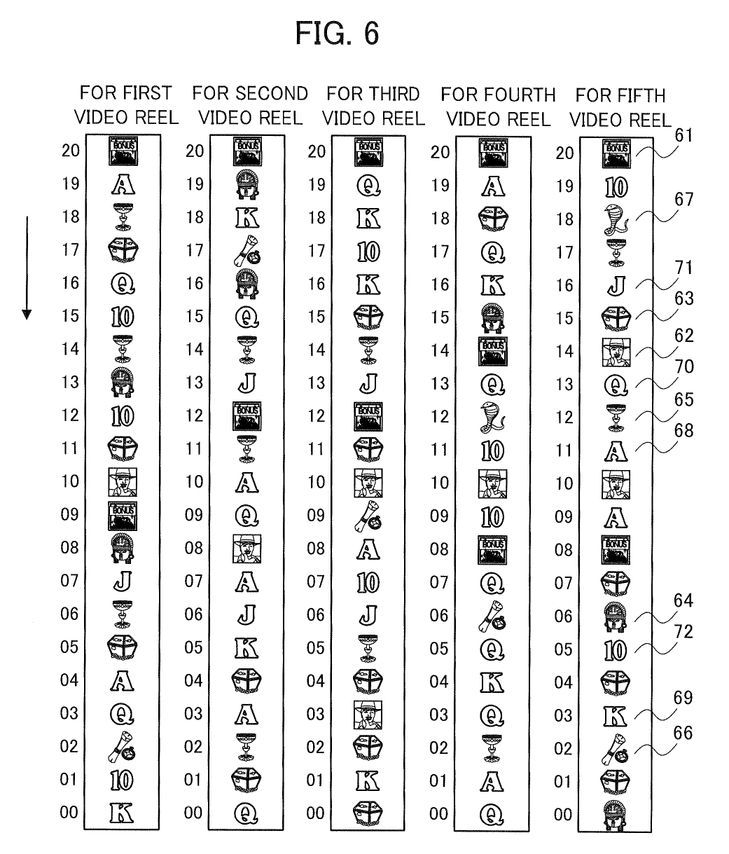

FIG. 6 shows columns of symbols where 21 symbols are represented and arranged on video reels 3A to 3E, respectively. It should be noted that the symbol sequence for the first video reel corresponds to the video reel 3A, the symbol sequence for the second video reel corresponds to the video reel 3B, the symbol sequence for the third video reel corresponds to the video reel 3C, the symbol sequence for the fourth video reel corresponds to the video reel 3D, and the symbol sequence for the fifth video reel corresponds to the video reel 3E. A plurality of symbols is arranged in each symbol column, and constitutes a symbol group.

As shown in FIG. 6, the code numbers “00” through “20” are assigned to the respective symbols of the symbol sequences for the video reels 3A through 3E. The code numbers are stored (recorded) in the aforementioned ROM 108 (FIG. 4) in the form of a data table.

A symbol sequence is depicted on each of the video reels 3A through 3E. Each symbol sequence includes: a “BONUS” symbol (symbol 61) (which will simply be referred to as “BONUS” hereafter); a “WILD” symbol (symbol 62) (which will simply be referred to as “WILD” hereafter); a “TREASURE BOX” symbol (symbol 63) (which will simply be referred to as “TREASURE BOX” hereafter); a “GOLDEN MASK” symbol (symbol 64) (which will simply be referred to as “GOLDEN MASK” hereafter); a “HOLY GRAIL” symbol (symbol 65) (which will simply be referred to as “HOLY GRAIL” hereafter); a “COMPASS & MAP” symbol (symbol 66) (which will simply be referred to as “COMPASS & MAP” hereafter); a “SNAKE” symbol (symbol 67) (which will simply be referred to as “SNAKE” hereafter); an “A” symbol (symbol 68) (which will simply be referred to as “A” hereafter); a “K” symbol (symbol 69) (which will simply be referred to as “K” hereafter); a “Q” symbol (symbol 70) (which will simply be referred to as “Q” hereafter); a “J” symbol (symbol 71) (which will simply be referred to as “J” hereafter); and a “10” symbol (symbol 72) (which will simply be referred to as “10” hereafter). Each of the symbol sequences on the video reels 3A through 3E is moved by displaying a video image in which the corresponding video reels 3A through 3E are rotated in the forward direction.

In the present embodiment, “BONUS”, “WILD”, “SNAKE”, “TREASURE BOX”, “GOLDEN MASK”, “HOLY GRAIL”, “COMPASS&MAP”, “A”, “K”, “Q”, “J”, and “10” are provided as the combination for providing a predetermined award. Basically, the combination (combination data) is control information which associates advantages given to a player (the numbers of coins paid out) to winning symbol combinations, and which is used for the stopping control of the video reels 3A to 3E, the switching (conversion) of the state of the game, and the supply of coins.

FIG. 7 shows a symbol layout table. In the symbol layout table, the individual symbols on the video reels 3A to 3E are registered in association with the code numbers designating the positions of the symbols in the aforesaid columns of symbols. It should be noted that the first through fifth video reels correspond to the video reels 3A through 3E, respectively. In other words, the symbol layout table provides symbol information with respect to the symbol positions (code numbers) on the video reels 3A to 3E.

In FIG. 7, the aforementioned award types “TREASURE BOX”, “GOLDEN MASK”, and “COMPASS&MAP” are abbreviated as “TREASURE”, “MASK”, and “COMPASS”, respectively.

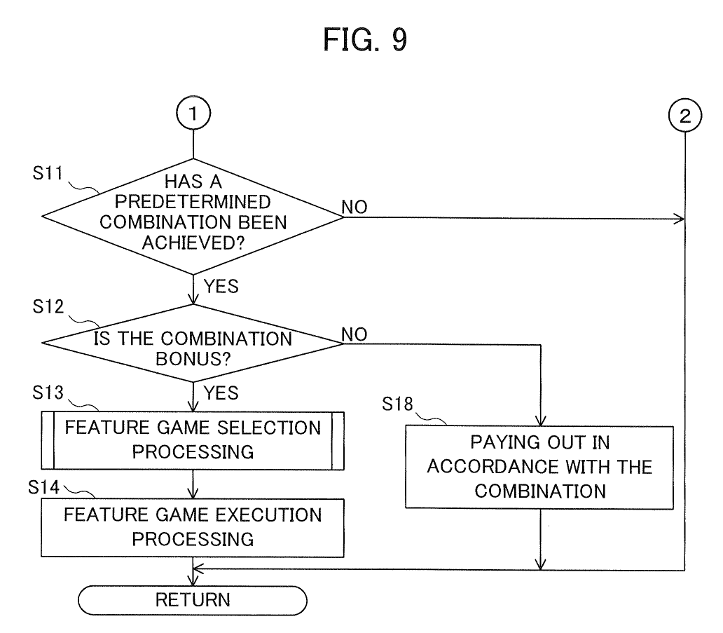

FIGS. 8 and 9 show a flow chart showing the processing of the basic game of the gaming machine 13, executed by the game controller 100 of the gaming machine 13. The one routine shown in FIGS. 8 and 9 corresponds to one execution of a unit game.

It is supposed that the gaming machine 13 is activated in advance and the variables used in the CPU 106 on the game controller 100 are initialized to predetermined values, thereby providing stationary operation of the gaming machine 13.

First, the CPU 106 included in the aforementioned game controller 100 determines whether any credits, i.e. the coins inserted by the player, remain or not (Step S1). More specifically, the CPU 106 reads the credit amount C stored in the RAM 110, and performs the processing based upon the credit amount C thus read. In a case where the credit amount C is “0” (in the case of a NO determination in Step S1), the CPU 106 is not permitted to start the game. Accordingly, in this case, the CPU 106 ends this routine without performing any processing. On the other hand, in a case where the credit amount C is at least “1” (in the case of a YES determination in Step S1), the CPU 106 determines that there is credit remaining, and accordingly advances to Step S2.

In Step S2, the CPU 106 determines whether a pushing operation has been performed or not, on the spin repeat bet switch 24. In a case where the spin repeat bet switch 24 has been pushed, and accordingly, in a case of reception of an operation signal via the spin repeat bet switch 24 (in the case of YES determination in Step S2), the CPU 106 advances to Step S15. On the other hand, in a case of no operation signal received via the spin repeat bet switch 24 during a predetermined period of time (in the case of a NO determination in Step S2), the CPU 106 determines that the spin repeat bet switch 24 has not been pushed, and accordingly advances to Step S3.

In Step S3, the CPU 106 sets the game condition. More specifically, the CPU 106 determines the number of coins to be bet on the active pay lines set in the current game according to the user's operation via the BET switch 23. In this step, the CPU 106 receives an operation signal generated by the user's operation performed via the BET switch 23. The CPU 106 determines the bet amount for each active pay line based upon the number of instances of reception of the BET switch operation signal, and stores the bet amount thus determined in a predetermined memory region in the RAM 110. The CPU 106 reads out the credit amount C written in a predetermined memory region in the RAM 110. Then, the CPU 106 subtracts the total bet amount, which is the sum total of the bet amounts, from the credit amount C thus read out, and stores the value thus subtracted in a predetermined memory region in the RAM 110. The CPU 106 then advances to Step S4.

In Step S4, the CPU 106 determines whether the side bet switch 4 has been pushed or not. In a case where the side bet switch 24 has been pushed, and accordingly, in a case of reception of an operation signal via the side bet switch 4 (in the case of a YES determination in Step S4), the CPU 106 advances to Step S5. On the other hand, in a case where no operation signal is input via the side bet switch 4 for a predetermined period of time (in a case of a NO determination in Step S4), the CPU 106 determines that the spin repeat bet switch 24 has not been pushed, and accordingly advances to Step S5. It should be noted that an operation of the start switch is equivalent to a NO determination in Step S4.

In Step S5, the CPU 106 performs side bet accepting processing. Before accepting a side bet, the CPU 106 reads a credit amount C written in a predetermined memory region in RAM 110, determines whether the credit amount C is at least the credit amount required for a predetermined side bet or not, and, in a case where the credit amount C is at least the credit amount required, subtracts the credit amount required from the credit amount C. The CPU 106 then activates a side bet accepting flag, which indicates that a side bet is made, and writes the flag in a predetermined memory region in the RAM 110. The side bet display unit 51 indicates the receipt of a side bet, or displays the side bet amount. On the other hand, in a case where the credit amount C is smaller than the credit amount required for a side bet, the CPU 106 does not accept the side bet (no activation of the side bet accepting flag), and advances to Step S6.

In Step S6, the CPU 106 waits for the operation of the start switch 25 by determining whether the start switch 25 is ON or not. In a case where the start switch 25 is operated and an operation signal is received via the start switch 25 (in the case of a YES determination in Step S6), the CPU 106 determines that the start switch 25 has been operated, and advances to Step S7.

On the other hand, in a case where the processing is advanced from Step S2 to Step S15, the CPU 106 determines whether the credit amount C is at least the total bet amount in the previous game. In other words, the CPU 106 determines whether or not the player can start the game by pushing the spin repeat bet switch 24. More specifically, in a case where the spin repeat bet switch 24 has been pushed, and accordingly, in a case where the operation signal has been input from the spin repeat bet switch 24, the CPU 106 reads out the credit amount C and the BET amount bet on each of the active pay lines L1 to L9 in the previous game stored in the predetermined memory areas of the aforementioned RAM 110. Then, the CPU 106 determines whether or not the aforementioned credit amount C is at least the total bet amount bet in the previous game based upon the relation between the credit amount C and the bet amounts thus read out. The CPU 106 performs processing based upon the determination results. In a case where the aforementioned credit amount C is determined to be less than the total bet amount bet on the previous game (in a case of a NO determination in Step S15), the CPU 106 cannot start the game, and accordingly terminates this routine without performing any processing. On the other hand, in a case where determination has been made that the aforementioned credit amount C is greater at least the total bet amount bet in the previous game (in a case of a YES determination in Step S15), the CPU 106 subtracts the total bet amount bet in the previous game from the aforementioned credit amount C, and stores the subtracted value in a predetermined area of the RAM 110. Subsequently, the CPU 106 advances to Step S16.

In Step S16, the CPU 106 determines whether the side bet switch 4 is ON or not, and advances to Step S17. In Step S17, the CPU 106 performs side bet accepting processing, and advances to Step S7. Descriptions are omitted regarding the processing in Steps S16 and S17, which are similar to the processing in Steps S4 and S5.

In Step S7, the CPU 106 performs stationary symbol determination processing. More specifically, the stationary symbol determination processing is as follows.

The CPU 106 first retrieves 5 random numbers in the range of 0 to 255, generated by a random number generator 112, which correspond to the five reels 3A to 3E. The CPU 106 reads payout ratio setting data from ROM 108, and stores the data in RAM 110. Then, the CPU 106 references symbol weighted data corresponding to the payout ratio setting data, and determines code numbers for the reels 3A to 3E on the basis of the five random numbers selected (see FIG. 7). The code numbers for the reels 3A to 3E thus determined correspond to code numbers for symbols rearranged along the active pay line L5. For example, in a case where the CPU 106 determines the code numbers for the reels 3A to 3E to be “20”, “20”, “20”, “20”, and “20” respectively, the symbols displayed on the reels 3A to 3E are all “BONUS”.

In Step S8, the CPU 106 displays an image of the five video reels 3A to 3E starting to rotate. More specifically, the CPU 106 displays an image of the video reels 3A to 3E starting to rotate in a predetermined order or simultaneously according to the symbol layout table stored in the RAM 110.

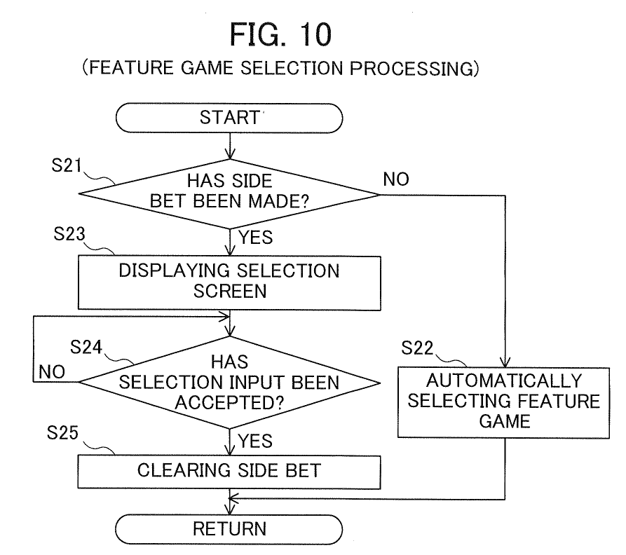

After beginning to display a video image of the video reels 3A through 3E starting to rotate, the CPU 106 waits for a predetermined period of time to elapse (Step S9). After the predetermined period of time has elapsed (at the moment of a YES determination in Step S9), the CPU 106 stops rotation of the video reels 3A to 3E (Step S10). More specifically, the CPU 106 displays an image of the video reels 3A to 3E stopping rotation in a predetermined order or simultaneously, to arrange the symbols having the code numbers determined in Step S7 along the active pay line L5. The CPU 106 then advances to Step S11 of FIG. 10.

In Step S11, after stopping rotation of the video reels 3A to 3E, the CPU 106 determines whether a predetermined symbol has been formed or not, along active pay lines activated in accordance with the bet amount. More specifically, after arranging the symbols along the active pay line L5 based upon the code numbers determined in Step S5, the CPU 106 determines whether the combination of the symbols with respect to the active pay lines matches any one of the particular winning combinations. In a case where the combination of the stationary symbols with respect to the active pay lines matches any one of the particular winning combinations, the CPU 106 activates a flag indicating that the player has won an award and indicating the type of winning combination, in order to provide the award. The CPU 106 stores the activated flag, indicating that the player has won an award, in a predetermined area in the RAM 110. On the other hand, in a case where the combination of the stationary symbols with respect to the active pay lines matches any one of the other combinations, i.e. the a losing combination, the CPU 106 does not activate the flag indicating that the player has won an award.

In a case where the flag indicating an award has not been activated, in other words, in a case where the symbol combination matches any one of the “other” combinations (in the case of a NO determination in Step S11), the CPU 106 determines that the particular winning combination has not been formed, and terminates the routine. On the other hand, in a case where the flag indicating an award has been activated, in other words, in a case where the symbol combination matches any one of the combinations other than the “other” combinations (in the case of a YES determination in Step S11), the CPU 106 advances to Step S12.

In Step S12, the CPU 106 determines whether the symbol combination thus formed is “BONUS” or not. More specifically, in a case where the particular winning combination is “BONUS” (in the case of a YES determination in Step S12), the CPU 106 advances to Step S13. On the other hand, in a case where the particular winning combination is not “BONUS” (in a case of a NO determination in Step S12), the CPU 106 advances to Step S18.

In Step S13, the CPU 106 performs feature game selection processing. This process is further explained later. Afterwards, the CPU 106 executes the feature game selected in Step S13, and terminates the routine.

On the other hand, after advancing from Step S12 to Step S18, the CPU 106 pays out coins, the number of which corresponds to the particular winning combination. More specifically, the CPU 106 calculates, with reference to the payout table, the number of coins to be paid out for the abovementioned winning combination. The CPU 106 reads the credit number stored in the predetermined memory area of the RAM 110, and adds the calculated payout number to the read credit number, and then stores the resulting value in a predetermined memory area in the RAM 110. The CPU 106 displays the value thus stored on the credit amount display portion 49. The CPU 106 then terminates the present routine.

The feature game processing is described below with reference to FIG. 10.

In Step S21, the CPU 106 determines whether a side bet has been accepted or not. More specifically, the CPU 106 makes the determination based upon the side bet accepting flag stored in a predetermined memory region in the RAM 110. In a case where the side bet accepting flag is activated (in the case of a YES determination in Step S21), the CPU 106 advances to Step S23. In a case where the side bet accepting flag is not activated (in the case of a NO determination in Step S21), the CPU 106 advances to Step S22.

In Step S22, the CPU 106 reads a feature game selection table (FIG. 11) described later, randomly selects a feature game to be executed in Step S14 in FIG. 9, and activates and stores a feature game flag of the selected feature game in a predetermined memory region in the RAM 110. The CPU 106 then terminates the present routine, and advances to Step S14 of FIG. 9.

In Step S23, the CPU 106 displays a feature game selection screen on a liquid crystal display 30. More specifically, the CPU 106 transmits an instruction signal to the display/input controller 140 for displaying the selection screen on the liquid crystal display 30. After receiving the instruction signal, a CPU 146 of the display/input controller 140 transmits a signal to a VDP 152, reads data for the selection screen from image ROM 156, and displays the data on the liquid crystal display 30.

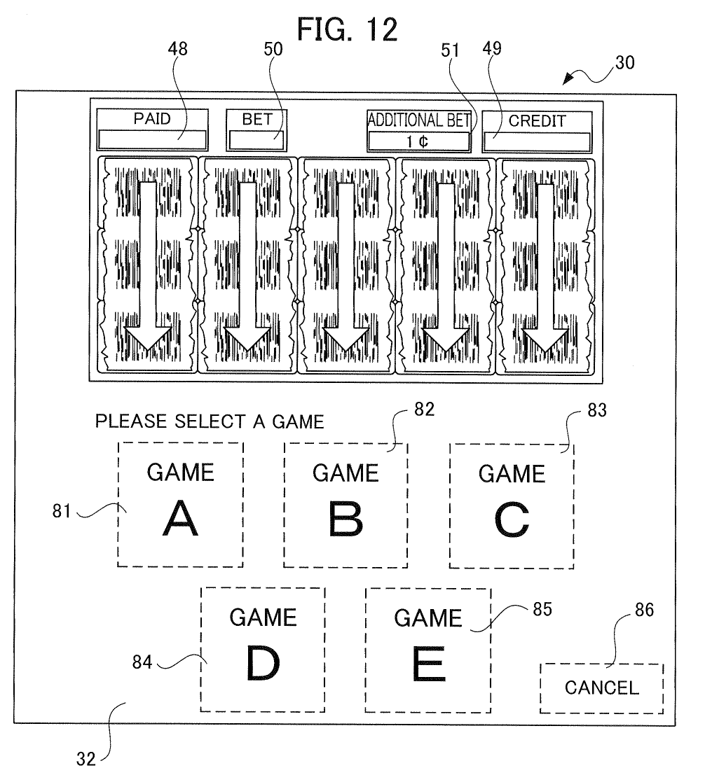

In Step S24, the CPU 106 determines whether a selection of a feature game has been accepted or not. More specifically, the CPU 106 determines whether an operation signal has been received or not from any one of selection regions 81 to 85 (see FIG. 12) of the touch panel 32, displayed on the liquid crystal display 30. The CPU 106 then stores the type of the selected feature game in a predetermined memory region in the RAM 110.

In Step S25, the CPU 106 clears the side bet. More specifically, the CPU 106 deactivates the side bet accepting flag stored in a predetermined storage region in the RAM 110. In this way, the side bet can be cleared in each game. The CPU 106 then advances to Step S14 of FIG. 9.

The feature game selection table is hereinafter described with reference to FIG. 11. The feature game selection table is referenced in Step S22 of FIG. 10. In other words, in the absence of a side bet, the CPU 106 uses the feature game selection table to select a feature game from a plurality of feature games.

The feature game selection table is referenced by the CPU 106 in Step S22 of FIG. 10. Types of feature games and random number ranges are associated to each other in the feature game selection table. The CPU 106 determines a random number range, defined in the feature game selection table, in which the random number picked up from the random number generator 112 is included. The feature game associated with the random number region is selected in Step S22 of FIG. 10. For example, in a case where the random number generated by the random number generator 112 is 10000, the random number range is “0 to 32767”. The feature game A is thus selected, which is associated to the random number range.

The feature game selection screen is hereinafter described with reference to FIG. 12.

The liquid crystal display 30 displays the video reels 3A to 3E and feature game selection regions 81 to 85. The feature game selection regions 81 to 85 show types of feature games and provide options. When a player touches any one of the selection regions 81 to 85, the touch panel 32 detects the touch, and a feature game associated with the one of the selection regions 81 to 85 is selected. Players can thus select a desired feature game from a plurality of feature games. A selection region 86 for cancelling the selection can also be displayed on the liquid crystal display 30. The selection can thus be cancelled.

### SECOND EMBODIMENT

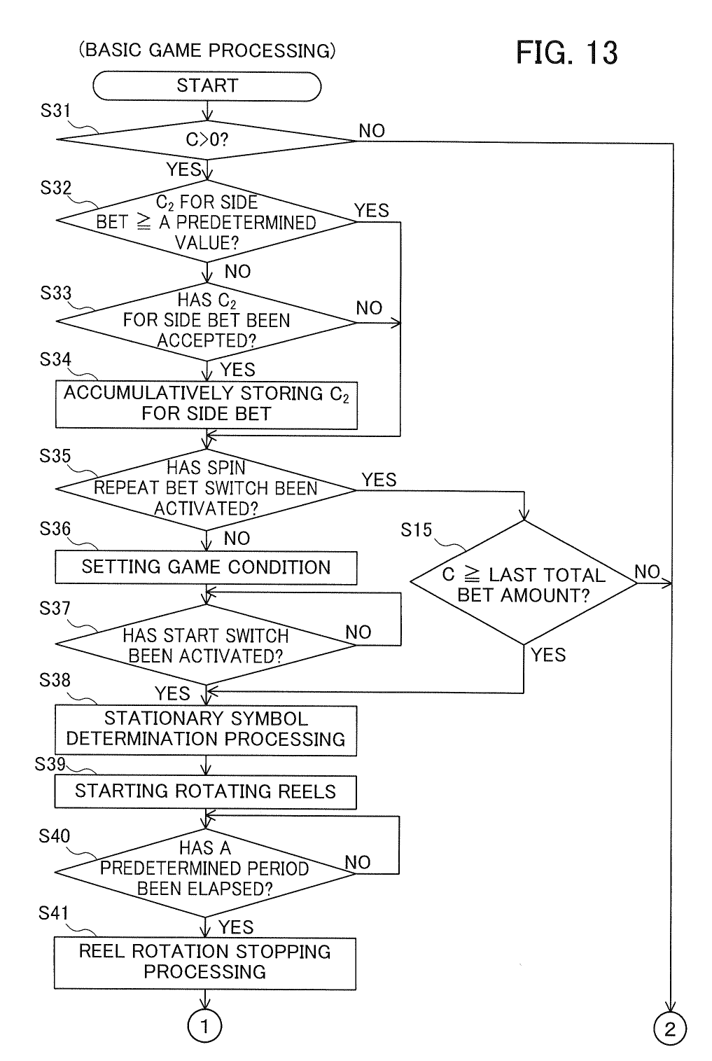

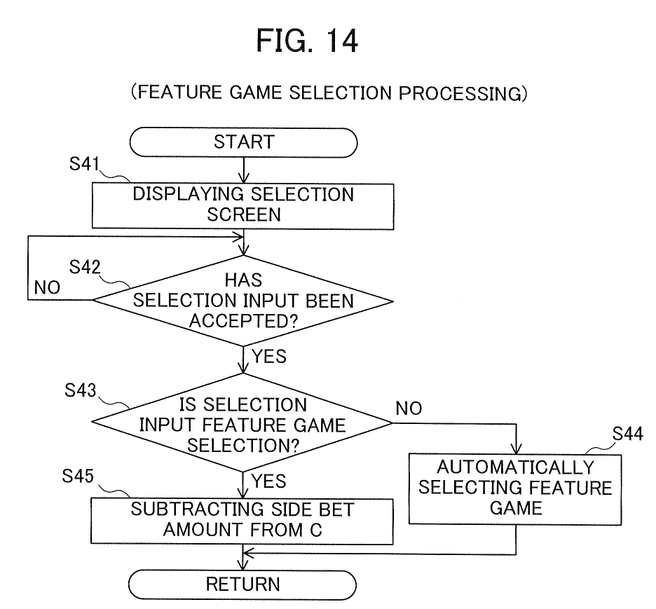

A second embodiment of the present invention is described hereinafter with reference to FIGS. 13 and 14. The second embodiment is different from the first embodiment in that, credits for making a side bet are additively stored in advance in a predetermined memory region in the RAM 110, and the amount required for making a side bet is subtracted therefrom each time a side bet is made. It should be noted that the difference from the first embodiment is mainly described. Accordingly, descriptions for the same components as those in the first embodiment are omitted. The same components as those in the first embodiment are referenced by the same reference numbers.

FIG. 13 is a flowchart showing basic game processing according to the second embodiment.

First, the CPU 106 determines whether any credits, i.e. the coins inserted by the player, remain or not (Step S31). This processing is similar to Step S1 of FIG. 8 of the first embodiment. In a case where the credit amount C is “0” in this processing (in the case of a NO determination in Step S31), the CPU 106 terminates this routine without performing any processing. On the other hand, in a case where the credit amount C is at least “1” (in the case of a YES determination in Step S31), the CPU 106 determines that there is credit remaining, and accordingly advances to Step S32.

In Step S32, the CPU 106 determines whether credits for the side bet remain or not (Step S32). More specifically, the CPU 106 reads the credit amount for the side bet C₂ stored in the RAM 110, and performs the processing based upon the credit amount C₂. In a case where the credit amount for the side bet C₂ is greater than a predetermined value required for another bet (in the case of a NO determination in Step S32), the CPU 106 advances to Step S35. On the other hand, in a case where the credit amount C₂ is greater than the predetermined value (in the case of a YES determination in Step S32), the CPU 106 advances to Step S33.

In Step S33, the CPU 106 determines whether credits for the side bet have been accepted or not. In this processing, the CPU 106 accepts another insertion of credits for the side bet. The credits can be additionally inserted from the coin slot or transferred from the credit C, stored in the predetermined storage region in the RAM 110, as the credit C₂ for the side bet. The credit C₂ can be transferred by pushing the side bet switch. In a case where the credit amount for the side bet C₂ is additionally inserted (in the case of a YES determination in Step S33), the CPU 106 advances to Step S34. On the other hand, in a case where no additional bet is accepted for a predetermined period of time (in a case of a NO determination in Step S33), the CPU 106 advances to Step S35.

In Step S34, the CPU 106 accumulatively stores the additionally inserted credits in the predetermined storage region in the RAM 110. The CPU 106 then advances to Step S35.

In Step S35, the CPU 106 determines whether a pushing operation has been performed on the spin repeat bet switch 24 or not. This processing is similar to Step S2 of the first embodiment, and therefore a description thereof is not repeated. In the case of a YES determination in this processing, the CPU 106 advances to Step S35. On the other hand, in the case of a NO determination in this processing, the CPU 106 advances to Step S36.

In Step S36, the CPU 106 sets the game condition. This processing is similar to Step S3 of the first embodiment, and therefore the description thereof is not repeated. After this processing, the CPU 106 advances to Step S37.

In Step S37, the CPU 106 waits for the operation of the start switch 25 by determining whether the start switch 25 is ON or not. This processing is similar to Step S6 of the first embodiment, and the following processing is similar to that of the first embodiment. Therefore, a description thereof is not repeated.

The feature game processing according to the second embodiment is described below with reference to FIG. 14.

First, in Step S41, the CPU 106 displays a feature game selection screen on the liquid crystal display 30. More specifically, the CPU 106 transmits an instruction signal to the display/input controller 140 for displaying the selection screen on the liquid crystal display 30. After receiving the instruction signal, a CPU 146 of the display/input controller 140 transmits a signal to a VDP 152, reads data for the selection screen from image ROM 156, and displays the data on the liquid crystal display 30.

In Step S42, the CPU 106 determines whether a selection of a feature game has been accepted or not. More specifically, the CPU 106 determines whether an operation signal is received or not from any one of the selection regions 81 to 86 in the touch panel 32, displayed on the liquid crystal display 30. The CPU 106 then stores the option selected in a predetermined memory region in the RAM 110.

In Step S43, the CPU 106 determines whether the accepted selection is a selection of a feature game or not. More specifically, the CPU 106 determines whether the option stored in the predetermined memory region in the RAM 110 is “CANCEL,” an option for not selecting a feature game, or not. In a case where the option is “CANCEL” (in the case of a NO determination in Step S43), the CPU 106 advances to Step S44. In a case where the option is not “CANCEL” (in the case of a YES determination in Step S43), the CPU 106 advances to Step S45.

In Step S44, the CPU 106 reads the feature game selection table, randomly selects a feature game to be executed, and stores the result thereof in a predetermined memory region in the RAM 110. This processing is similar to Step S22 of FIG. 10 of the first embodiment. The CPU 106 then terminates this subroutine.

In Step S45, the CPU 106 performs processing of subtracting the side bet amount from the credits for the side bet C₂. More specifically, the CPU 106 subtracts the side bet amount from the credits for the side bet C₂ stored in the predetermined storage region in the RAM 110, and newly stores the resulting value to the predetermined storage region. The CPU 106 then terminates this subroutine.

While the embodiments of the gaming machine according to the present invention have been described, it is to be understood that the above descriptions are intended to be illustrative, and not restrictive, and any changes in design may be made to specific configurations such as various means. It is also to be understood that the effects described in the foregoing embodiments are intended to be illustrative as preferred effects that the present invention can produce, and the effects according to the present invention are not limited to that described in the foregoing embodiment.

For example, the gaming machine includes the video reels 3A to 3E in the above embodiments; however, the present invention is not limited thereto and can be of a scatter type. In other words, symbols to be rearranged can be determined for the whole symbol display region, for each column, or for each row, and displayed. In this case, it is determined whether a predetermined combination is achieved among the rearranged symbols.

Furthermore, the selection and the execution of the feature game is allowed in a case where a bonus combination is achieved in the above embodiments; however, the present invention is not limited thereto, and the feature game can be selected by a side bet for a second game, a mini game, and the like.

In the above embodiments, the players can select the feature game in a case where a side bet is made; however, the present invention is not limited thereto. For example, the feature game can be selected in accordance with the side bet amount. In this case, a table is provided, in which side bet credit amounts and a plurality of feature games are associated with each other, to determine the feature game to be executed in accordance with the side bet credit amount. Furthermore, a feature game of higher return can be selected for a greater side bet credit amount.

What is claimed is:

1. A gaming machine comprising:
a display for displaying a predetermined symbol from each of a plurality of symbol groups;
an input device for accepting a selection of a second game from a plurality of second games in a case in which an additional bet is accepted, where the additional bet is made together with a bet for a first game;
memory for storing the additional bet;
and a controller for executing steps of:
(a) storing the additional bet in the memory;
(b) generating random numbers and starting the first game;
(c) dynamically displaying each of the plurality of symbol groups on the display;
(d) determining the symbol to be statically displayed on the display, in accordance with the random numbers;
(e) statically displaying each symbol determined in step (d);
(f) determining whether a trigger symbol is displayed in a predetermined way in the plurality of symbols, wherein the trigger symbol triggers a transition to the second game;
(g) in response to processing of step (f), displaying a selection image on the display for selecting the second game to be executed, in a case where a transition to the second game is taking place and where the additional bet is being accepted;
(h) executing the second game in response to the selection thereof by the input device; and
(i) clearing the additional bet stored in the memory.

2. The gaming machine according to claim 1, wherein, in a case where the additional bet is not being accepted, the controller randomly selects the second game from the plurality of second games in steps (g) and (h).

3. A gaming machine comprising:
a display for displaying a predetermined symbol from each of a plurality of symbol groups;
an input device for accepting a selection of a second game from a plurality of second games in a case in which an additional bet is accepted, where the additional bet is made together with a bet for a first game;
memory for storing the additional bet;
and a controller for executing steps of:
(a) in a case where the additional bet is accepted, storing a value of the additional bet in the memory by adding thereof to a value stored in the memory;
(b) generating random numbers and starting the first game;
(c) dynamically displaying each of the plurality of symbol groups on the display;
(d) determining a symbol to be statically displayed on the display, in accordance with the random numbers;
(e) statically displaying the symbol on the display, in response to processing of step (d);
(f) determining whether a trigger symbol is displayed in a predetermined way in the plurality of symbols, wherein the trigger symbol triggers a transition to the second game;
(g) in response to processing of step (f), displaying a selection image on the display for selecting the second game to be executed, in a case where a transition to the second game is taking place and where the additional bet is being accepted;
(h) executing the second game in response to the selection thereof by the input device; and
(i) subtracting a value corresponding to the second game executed in step (h) from the value of the additional bet, and storing the result thereof in the memory.

4. The gaming machine according to claim 3, wherein, in a case where the additional bet is not being accepted, the controller randomly selects the second game from the plurality of second games in steps (g) and (h).

5. A control method for a gaming machine having:
a display for displaying a predetermined symbol from each of a plurality of symbol groups;
an input device for accepting a selection of a second game from a plurality of second games in a case in which an additional bet is accepted, where the additional bet is made together with a bet for a first game;
memory for storing a value of the additional bet;
and a controller for executing the method,
the method comprising steps of:
(a) storing the additional bet in the memory;
(b) generating random numbers and starting the first game;
(c) dynamically displaying each of the plurality of symbol groups on the display;
(d) determining the symbol to be statically displayed on the display, in accordance with the random numbers;
(e) statically displaying each symbol determined in step (d);
(f) determining whether a trigger symbol is displayed in a predetermined way in the plurality of symbols displayed, wherein the trigger symbol triggers a transition to the second game;
(g) in response to processing of step (f), displaying a selection image on the display for selecting the second game to be executed, in a case where a transition to the second game is taking place and where the additional bet is being accepted;
(h) executing the second game in response to the selection thereof by the input device; and
(i) clearing the additional bet stored in the memory.

6. The gaming machine according to claim 5, wherein, in a case where the additional bet is not being accepted, the controller randomly selects the second game from the plurality of second games in steps (g) and (h).

7. A control method for a gaming machine having:
a display for displaying a predetermined symbol from each of a plurality of symbol groups;
an input device for accepting a selection of a second game from a plurality of second games in a case in which an additional bet is accepted, where the additional bet is made together with a bet for a first game;
memory for storing the additional bet;
and a controller for executing the method,
the method comprising steps of:
(a) in a case where the additional bet is accepted, storing a value of the additional bet in the memory by adding thereof to a value stored in the memory;
(b) generating random numbers and starting the first game;
(c) dynamically displaying each of the plurality of symbol groups on the display;
(d) determining a symbol to be statically displayed on the display, in accordance with the random numbers;
(e) statically displaying the symbol on the display, in response to processing of step (d);
(f) determining whether a trigger symbol is displayed in a predetermined way in the plurality of symbols, wherein the trigger symbol triggers a transition to the second game;
(g) in response to processing of step (f), displaying a selection image on the display for selecting the second game to be executed, in a case where a transition to the second game is taking place and where the additional bet is being accepted;
(h) executing the second game in response to the selection thereof by the input device; and
(i) subtracting a value corresponding to the second game executed in step (h) from the value of the additional bet, and storing the result thereof in the memory.

8. The control method according to claim 7, wherein, in a case where the additional bet is not being accepted, the controller randomly selects the second game from the plurality of second games in steps (g) and (h).
